(19) United States
(12) Patent Application Publication
(10) Pub. No.: US 2025/0346016 A1
(43) Pub. Date: Nov. 13, 2025

(54) COMPOSITE SANDWICH STRUCTURE

(71) Applicant: Shkamb Koshi, llandriano (IT)

(72) Inventor: Shkamb Koshi, llandriano (IT)

(21) Appl. No.: 19/095,725

(22) Filed: Mar. 31, 2025

Related U.S. Application Data
(63) Continuation-in-part of application No. 18/086,578, filed on Dec. 21, 2022, now abandoned.
(60) Provisional application No. 63/402,956, filed on Sep. 1, 2022.

(51) Int. Cl. B32B 3/18; B32B 5/18; B32B 7/12

(52) U.S. Cl. CPC B32B 3/18; B32B 5/18; B32B 7/12; B32B 2250/03; B32B 2250/40; B32B 2307/72; B32B 2607/00

(57) ABSTRACT

A composite sandwich structure that includes core units arranged side-by-side in series to form a core panel. The series of core units are sandwiched between the outer upper skin and the outer lower skin to form the composite sandwich structure. The core unit includes a low-density stripe fully wrapped around with a reinforcing fiber sheet. The reinforcing fiber sheet is adhered to the low-density stripe using an adhesive.

### CROSS-REFERENCE TO RELATED APPLICATIONS

This application is a continuation in part of a U.S. patent application Ser. No. 18/086,578 filed on Dec. 21, 2022, which claims priority from a U.S. Provisional Patent Appl. No. 63/402,956 filed Sep. 1, 2022, both of which are incorporated herein by reference in their entirety.

### FIELD OF INVENTION

The present invention relates to a composite sandwich structure, and more particularly, the present invention relates to a panel with laminated core blocks in which the core block is laminated with reinforcement fibers.

### BACKGROUND

Composite sandwich structures are a special type of composite structure in which a lightweight core is sandwiched between two skins of laminate. The composite sandwich structures have high bending stiffness with overall low density because of the thick and low-density core. Composite sandwich structures are used in many applications, such as wings of airplanes, hulls of boats, and many others. Besides being widely used, the known composite sandwich structures suffer from one major limitation, i.e., delamination when the composite sandwich structure is put under excessive effort/force/stress. Under these conditions, the material inside the composite sandwich structure can separate/detach/break/cut/delaminate. The division/break usually happens at the most stressed point of the structure, i.e., the middle. The stress is caused by two opposite forces: flexion and compression.

The delamination negatively affects the compactness of all materials in the structure, and therefore the performance of the structure (its materials no longer work in the same way). The core foam is the soul of the sandwich; it keeps the outer and inner layers of fibers compact and makes them mechanically work together. The core foam allows it to reach very high thickness, and therefore rigid characteristics in the final product, without increasing the weight of the structure.

All the core foams on the market suffer from cuts/delamination when the final product is subjected to continuous stress. This is due to their poor mechanical characteristics. For example, a PCT application WO2012/125224, assigned to Tompkins, titled “Fiber Reinforced Core Panel Able To Be Contoured,” discloses a fiber-reinforced core panel containing a series of adjacent, substantially parallel low-density strips and a continuous fibrous reinforcement sheet threaded through the low-density strips. FIGS. 7a, 8a, and 9a show the core panels made through Tompkin's process. As visible in the drawings, the strips in the core panel are not uniformly organized, and the process is complicated. Not all sides and/or corners are strengthened using a fiber-reinforcing sheet. This results in delamination and low structural strength of the core panel. Also, the shapes of the core panel that can be formed are limited.

A need is therefore appreciated for improved composite sandwich structures that are devoid of the aforementioned drawbacks of conventional composite sandwich structures.

The term stripe(s) hereinafter refers to a block of foam cut from a foam panel. Preferably, the foam is a low-density foam, unless otherwise mentioned.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a novel composite sandwich structure in which the risk of delamination is significantly reduced.

It is another object of the present invention that the weight of the composite sandwich structure is significantly reduced.

It is still another object of the present invention that the method facilitates manual placement of the composite sandwich structure.

Another object of the present invention is that the composite sandwich structure is highly adaptable to complex geometric shapes.

Still, another object of the present invention is that the composite sandwich structure is highly efficient with less weight.

In one aspect, a composite sandwich structure is disclosed that includes a core layer sandwiched between a top layer and a bottom layer. The core layer includes a series of fiber-reinforced low-density strips, which are arranged substantially parallel to each other. Each low-density strip is reinforced by wrapping 360 degrees with a fibrous reinforcing sheet adhered using suitable resin. The top layer and the bottom layer may be continuous fibrous reinforcing sheets.

In one aspect, the shape and arrangement of the core units in the composite sandwich structure may vary to obtain complex-shaped composite sandwich structures.

In one aspect, the low-density strips feature at least three faces (a primary face, a first edge face, a second edge face, and optionally, a secondary face), with the primary face of each strip positioned on either the first or second side of the core panel.

In one aspect, the reinforcing fiber sheet can be adhered to the low-density strips using resins, double-sided adhesive tape, and spray glue. Also, the low-density strips do not require cutouts or incisions on their surfaces to enable the structure's impregnation with resin or adhesive film sheets.

In one aspect, an innovative process for forming fiber-reinforced core panels is disclosed that ensures better structural integration and greater mechanical strength compared to traditional techniques.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 illustrates the making of a core unit using a low-density stripe and fibrous reinforcing sheet, according to an exemplary embodiment of the present invention.

FIG. 2 shows a core unit of the composite sandwich structure, according to an exemplary embodiment of the present invention.

FIG. 3 shows an arrangement of low-density stripes in the composite sandwich structure, according to an exemplary embodiment of the present invention.

FIG. 4 shows the composite sandwich structure, according to an exemplary embodiment of the present invention.

FIGS. 5A-5D show different profiles of the low-density stripes for the composite sandwich structure, according to an exemplary embodiment of the present invention.

FIGS. 6A-6D show different composite sandwich structures made from the core units shown in FIGS. 5A-5D respectively, according to an exemplary embodiment of the present invention.

FIG. 7A shows a composite sandwich structure of prior art.

FIG. 7B shows the composite sandwich structure, according to an exemplary embodiment of the present invention.

FIG. 8A shows a composite sandwich structure of prior art.

FIG. 8B shows the core units arranged in series for forming the composite sandwich structure, according to an exemplary embodiment of the present invention.

FIG. 9A shows a composite sandwich structure of prior art.

FIG. 9B shows the core units, having triangular low-density stripes, arranged in series to form the composite sandwich structure, according to an exemplary embodiment of the present invention.

FIG. 10 shows a perspective view of a composite sandwich structure, wherein the structure exhibits curvature along the Y direction, according to an exemplary embodiment of the present invention.

FIG. 11 shows a perspective view of a fiber-reinforced core panel, according to an exemplary embodiment of the present invention.

FIG. 12 shows the core units made of trapezoidal-shaped low-density stripes, according to an exemplary embodiment of the present invention.

FIG. 13 shows the core units made of square-shaped low-density stripes, according to an exemplary embodiment of the present invention.

FIG. 14 shows the core units made of triangular-shaped low-density stripes, according to an exemplary embodiment of the present invention.

FIG. 15 shows the core units made of rectangular-shaped low-density stripes, according to an exemplary embodiment of the present invention.

FIG. 16 shows the core units made of vertically aligned rectangular-shaped low-density stripes, according to an exemplary embodiment of the present invention.

FIG. 17 shows the core units of rectangular and square shapes arranged alternatively in series for making a core panel, according to an exemplary embodiment of the present invention.

FIG. 18 shows the core units of trapezoid and triangular shapes arranged alternatively in series for making the core panel, according to an exemplary embodiment of the present invention.

FIG. 19 shows the core units of square, rectangular, and triangular shapes arranged in a specific configuration for making a core panel, according to an exemplary embodiment of the present invention.

FIG. 20 shows a composite sandwich structure made from core units of square, rectangular, and triangular shapes that are arranged in a specific configuration for making a core panel, according to an exemplary embodiment of the present invention.

FIG. 21 shows the composite sandwich structure made from square, trapezoidal, and triangular-shaped core units that are arranged in a specific configuration, according to an exemplary embodiment of the present invention.

FIG. 22 shows a rigid, lightweight foam panel cut into stripes having a square cross-section, according to an exemplary embodiment of the present invention.

FIG. 23 represents a reinforcing fiber sheet combined with a double-sided adhesive sheet, according to an exemplary embodiment of the present invention.

FIG. 24 illustrates a stripe positioned above a double-sided adhesive sheet and reinforcing fiber sheet, according to an exemplary embodiment of the present invention.

FIG. 25 shows steps in the manufacturing of a core unit, according to an exemplary embodiment of the present invention.

FIG. 26 shows a core unit being perforated with a hard-tipped tool, according to an exemplary embodiment of the present invention.

FIG. 27 shows core units with different arrangements of perforations, according to an exemplary embodiment of the present invention.

FIG. 28A shows a detailed view of a composite sandwich structure in which a low-density stripe has an excess polymer matrix (EX), caused by the porosity of the stripe itself and the presence of a reinforcing fiber sheet.

FIG. 28B illustrates a detailed view of the excess polymer matrix (EX), caused by the porosity of the surface of the low-density stripe and the reinforcing fiber.

FIG. 28C represents a detailed view of a composite sandwich structure in which a low-density stripe has no excess polymer matrix (EX), due to the use of a double-sided adhesive film and a reinforcing fiber sheet.

FIG. 28D illustrates a detailed view of the result achieved with the double-sided adhesive film, which ensures impermeability and reduces the excess polymer matrix (EX), keeping the reinforcing fiber sheet in optimal position.

FIG. 29 shows low-density foam sheets containing a series of perforations and cuts.

FIG. 30 shows different stripes with a series of cuts distributed on the primary and secondary faces, accompanied by perforations in various configurations.

FIG. 31 shows a composite sandwich structure including a series of core units of square profile, according to an exemplary embodiment of the present invention.

FIG. 32 shows a curved composite sandwich structure, according to an exemplary embodiment of the present invention.

FIG. 33 shows a boat hull made with composite sandwich structures with transverse and longitudinal reinforcements, according to an exemplary embodiment of the present invention.

FIG. 34 shows a wind turbine blade made with composite sandwich structures with longitudinal reinforcements, according to an exemplary embodiment of the present invention.

FIGS. 35A-35E shows an end view of the stages of the lamination process for producing the composite sandwich structure using triangular core units, according to an exemplary embodiment of the present invention.

FIG. 36 shows the sandwich composite structure, according to an exemplary embodiment of the present invention.

FIG. 37 shows a detailed view of the sandwich composite structure, where all the corners of the foam cores are reinforced with a reinforcing fiber sheet, according to an exemplary embodiment of the present invention.

FIG. 38 shows the sandwich composite structure that has square-shaped core units, according to an exemplary embodiment of the present invention.

FIG. 38A shows an enlarged view of the sandwich composite structure of FIG. 38, according to an exemplary embodiment of the present invention.

FIG. 39 shows the making of a hull using the disclosed sandwich composite structure, according to an exemplary embodiment of the present invention.

FIG. 40 shows the results of the breakage load test of the sandwich composite structure of prior art, according to an exemplary embodiment of the present invention.

FIG. 41 shows the results of the breakage load test of the disclosed sandwich composite structure, according to an exemplary embodiment of the present invention.

FIG. 42 shows the results of the load test of the sandwich composite structure of prior art, according to an exemplary embodiment of the present invention.

FIG. 43 shows the results of the load test of the disclosed sandwich composite structure, according to an exemplary embodiment of the present invention.

FIGS. 44A and 44B show comparison results for the disclosed sandwich composite structure and the prior art sandwich composite structure.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation.

Disclosed is a novel composite sandwich structure, also referred to herein as a composite sandwich panel, and a method for manufacturing thereof that, by having a novel orientation of the reinforcement fibers, significantly reduces the risks of breakage or delamination. The disclosed method is also advantageous by allowing for manual labor and unlimited shapes of the final product.

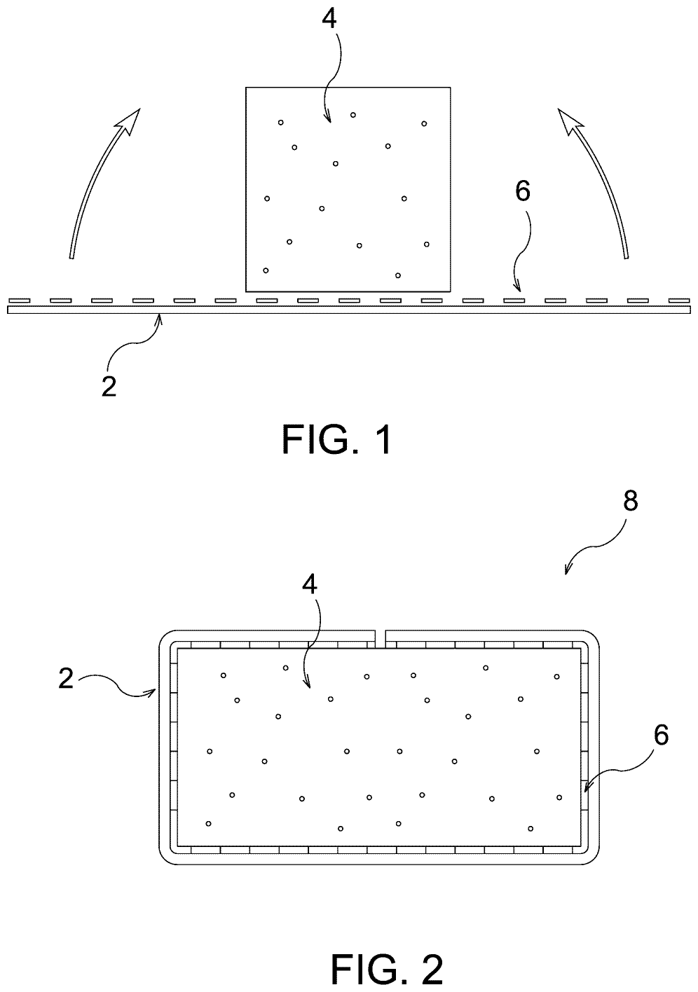

FIG. 1 illustrates an exemplary embodiment of manufacturing a low-density stripe of the disclosed composite sandwich structure. The disclosed composite sandwich structure includes a top layer, a bottom layer, and a series of low-density stripes sandwiched between the top layer and the bottom layer. Each of the top layer and the bottom layer may be made continuous sheet of reinforcement fibers. Each of the low-density stripes can be laminated with a continuous reinforcement fiber sheet for enhanced strength without increasing the overall weight of the composite. Each low-density stripe is fully and continuously wrapped around with a reinforcement fiber sheet. The opposite edges of the reinforcement fiber sheet end in the middle of a side of the low-density stripe having the largest surface area. This ensures that all the corners of the low-density stripe are reinforced with the fiber sheet. The opposite edges of the reinforcement fiber sheet may overlap, or touch each other, or a slight space may exist between the opposite edges. The continuous wrap around the low-density stripe may ensure that all the corners and sides of the low-density stripe are reinforced resulting in the uniform distribution of forces. This prevents any delamination and drastically reduces the possibility of breakage.

The reinforcement fibers used in the disclosed composite sandwich structure may be carbon fibers, glass fibers, Kevlar® fibers, and the like, fibers known to a skilled person for use in composite sandwich structures. The low-density stripe can be made of any suitable hard and low-density foam, such as, but not limited to, PVC, PET, Balsa®, and extruded polystyrene (XPS®). It may be preferable that the foam could be bent without breaking. Thus, the low-density stripe made of XPS® and like foam material may be preferable over hard foams that may break upon bending. It is to be understood that the low-density stripe may be made of any suitable material, and any such material is within the scope of the present invention.

In certain implementations, the disclosed composite sandwich structure includes a series of adjacent, substantially parallel, low-density stripes, each completely wrapped around in a reinforcing fiber sheet. The low-density stripes wrapped with the reinforcing fiber sheet may be of different shapes assembled to form complex shape sandwich composite structures.

In certain implementations, disclosed is a sandwich composite structure characterized by a series of adjacent, substantially parallel, low-density stripes, each fully wrapped around with a reinforcing fiber sheet. The low-density stripe can be manufactured in a range of shapes; however, the low-density stripe may include at least three faces i.e., a primary face, a first edge face, a second edge face, and optionally, a secondary face, with the primary face of each low-density stripe positioned on either the first or second side of the core panel. The opposite edges of the reinforcing fiber sheet wrapped around the low-density stripe may also end up in the middle of the primary face of the low-density stripe.

Unlike existing technologies, the foam cores, according to the present invention, do not necessarily require cuts or incisions on their surfaces to enable impregnation with resin. Furthermore, an innovative process for forming the fiber-reinforced core panel is disclosed, ensuring better structural integration and greater mechanical strength compared to traditional techniques. This core panel, made of low-density stripes wrapped with reinforcement fiber sheet, can be sandwiched between top and bottom layers to form the disclosed sandwich composite structure.

FIG. 1 illustrates the process of making a core unit of the disclosed composite sandwich structures using a reinforcing fiber sheet 2, a low-density stripe 4, and a double tape adhesive 6. The double tape adhesive 6 can be applied to the top side of the reinforcement fiber wrap 2. Thereafter, the low-density stripe 4 can be placed in the middle of the double tape adhesive 6. Thereafter, the reinforcing fiber sheet with the double tape adhesive can be wrapped around the low-density stripe. The reinforcing fiber sheet can be wrapped around the low-density stripe in a specific orientation, as shown in FIGS. 1 and 2 using a double adhesive tape. FIG. 2 shows the core unit 8 formed by the process shown in FIG. 1. Although the drawing shows the use of double adhesive tape, it is to be understood that any suitable adhesive, such as spray glue adhesive/resins, can be used. Any suitable adhesive is within the scope of the present invention.

The reinforcing fiber sheet can be completely wrapped around the low-density stripe as shown in FIG. 2. These reinforcements distribute stress away from the low-density stripe, improving strength. Although the low-density stripe may break upon bending, the low-density stripe wrapped with the reinforcing fiber sheet can be bent to a large degree without breakage. This is due to the uniform distribution of the forces by the fully wrapped-around reinforcing fiber sheet around the low-density stripe. The reinforcing fiber sheet has a proximal edge and a distal edge; the proximal edge and the distal edge are on opposite sides of the reinforcing fiber sheet. When wrapped, the proximal edge contacts the distal edge but may or may not overlap. It is to be noted that some gaps may exist between the proximal edge and the distal edge. Also, the proximal edge and the distal edge may lie longitudinally along the middle of the primary face of the low-density stripe.

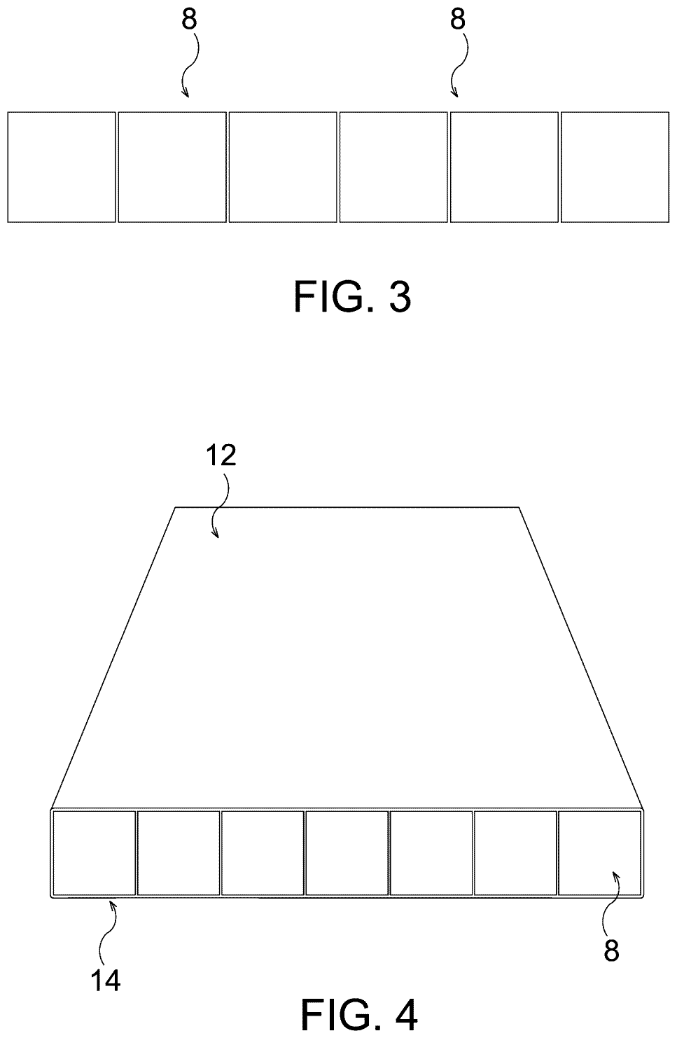

The core units, as shown in FIG. 2, can be arranged side-by-side in series to form the core panel of the sandwich composite structure. FIG. 3 shows such an arrangement of the low-density stripes, each wrapped with a reinforcing fiber sheet, and arranged side-by-side to form a core panel of the composite sandwich structure. This core panel may be sandwiched between the reinforcing top and bottom layers to form the disclosed sandwich composite structure. For sandwiching the core panel between the top layer and the bottom layer, suitable resins can be used. The use of such resins is known to a skilled person for making composite laminates. An exemplary embodiment of the composite sandwich structure 10 is shown in FIG. 4, which has a top layer 12, a core panel made from a series of core unit 8, and a bottom layer 14. Typically, the resin can be applied over the bottom layer, and the core units can be placed one by one over the bottom layer, and thereafter, the top layer can be applied, sandwiching the series of core units. Thus, the core panel herein may refer to a series of core units.

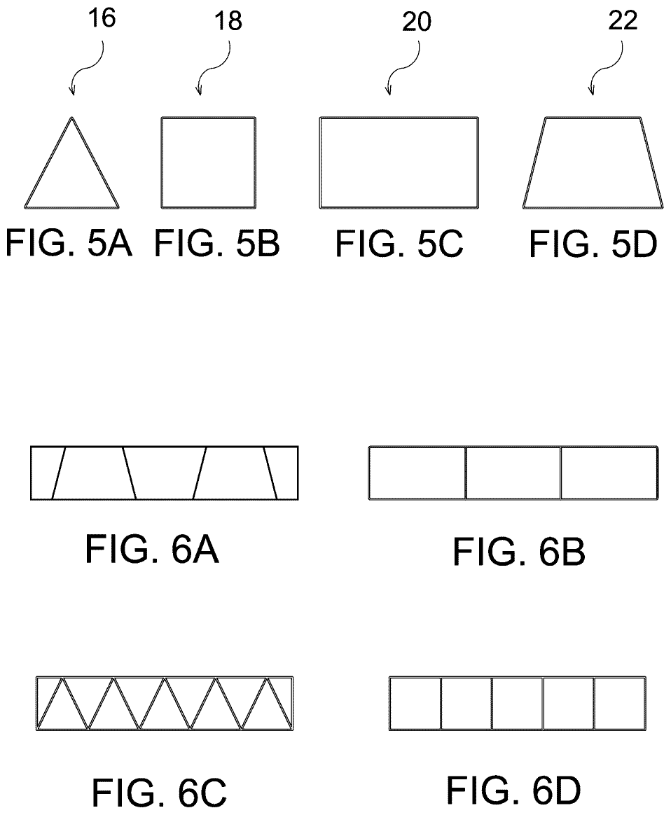

The low-density stripes can be manufactured in different profiles and sizes by cutting the foam into different shapes. FIG. 5A shows the low-density stripe 16 of a triangular profile, FIG. 5B shows the low-density stripe 18 of a square profile, FIG. 5C shows the low-density stripe 20 of a rectangular profile, and FIG. 5D shows the low-density stripe 22 of a trapezoid profile. FIGS. 6A-6D show the respective composite sandwich structures made from the low-density stripes shown in FIGS. 5A-5D.

The use of a double tape adhesive for attaching the reinforcing fiber sheet over the low-density stripe in manufacturing the core units achieves the best weight fiber/resin ratio because it minimizes the excess resin that can enter the open cells of the foam. The top and bottom reinforcing fiber layers can be laminated by any standard process known to a skilled person for manufacturing laminates, and any such process is within the scope of the present invention. The structure can be completed in one or two infusions. The two-infusion process reduces the surface distortions on the structure and is advised to avoid potential aesthetic anomalies. The two-infusion process consists of infusing the top layer (the externally visible one) on its own and post-curing it to stabilize it against thermal anomalies. Then the second infusion can be done to complete the structure.

The disclosed sandwich composite structure offers many advantages over conventional composite structures, including reduced weight (4× lighter than sandwich composite structures made with conventional process), increased robustness/stiffness, and increased structural durability. When used in boat construction, the disclosed composite sandwich structures offer additional advantages, including lower horsepower required/higher speed with the same horsepower; fuel efficiency; less maintenance required; and increased comfort during the ride because of the stiffness of the structure. The disclosed sandwich composite structure can be used in wind blades, bridges, infrastructure tooling and machinery, mega-constructions, aviation, and the like industries.

The disclosed sandwich composite structure was compared with a standard composite sandwich structure by using the same in a 31-foot center console boat. It was found that the boat using the disclosed sandwich composite structure weighs 1.5 tons compared to the 4-5 tons boat made with conventional composite structures. Both the top speed and the fuel efficiency were also significantly improved.

In one implementation, the low-density stripe can be wrapped with reinforcing fiber sheets of different weights and seams. Preferably, a biaxial +45/−45 fiber reinforcement can be used.

In one implementation, the disclosed method allows the use of more flexible and less dense low-density stripes, such as XPS®, that allow the core units to be positioned and bent by hand on the mold, making it quite easy to shape the composite sandwich structure on complex and irregular surfaces.

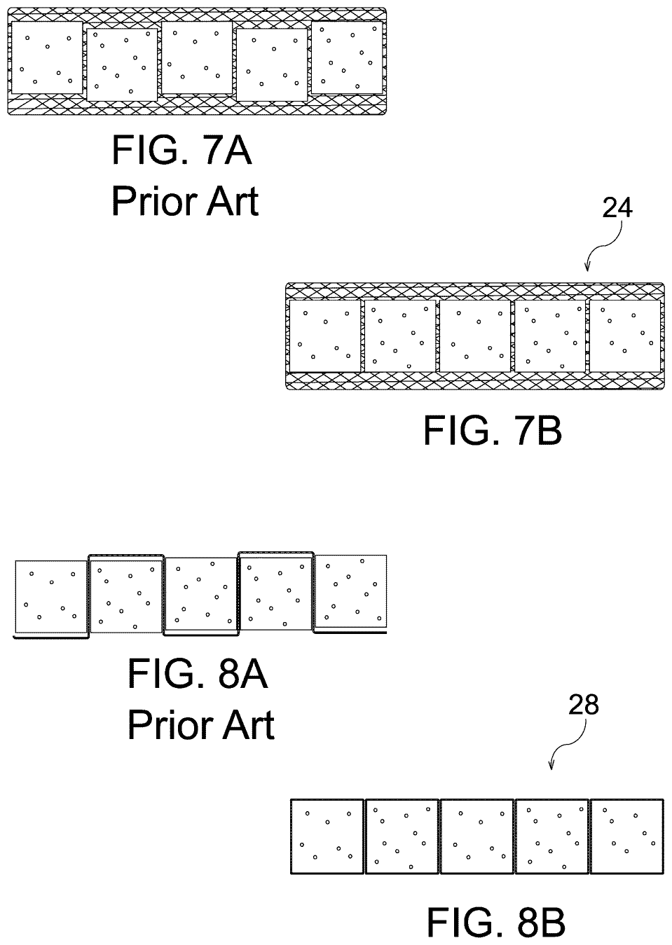

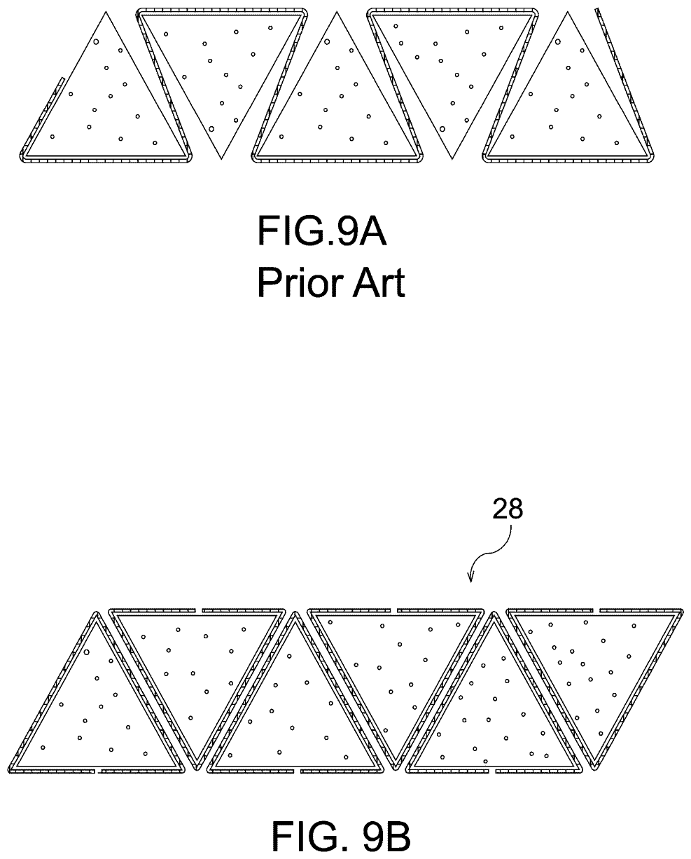

Another advantage of the disclosed composite sandwich structure is shown in FIGS. 7A and 7B. The composite sandwich structures made by conventional methods have the core units organized irregularly, as shown in FIG. 7A. This is due to the wrapping technique of reinforcing fiber sheets over the foam cores. For example, FIG. 8A shows the wrapping process described in PCT application WO2012/125224. This alternative wrapping of the foam cores results in a non-uniform arrangement of the foam cores. As shown in FIG. 8A, not all sides and corners of the foam core are reinforced by the fiber sheet. Even when using triangular-shaped foam cores, as shown in FIG. 9A, in the process of PCT application WO2012/125224, the corners of the foam cores are not reinforced by the fiber sheet. This significantly affects the strength of the core panel, resulting in lesser core strength and delamination. FIG. 7B shows the composite sandwich structure 24, according to the present invention, in which the core units 26 are arranged uniformly. Since the reinforcing fiber sheet completely wraps around each of the low-density stripes, this makes the disclosed composite sandwich structure stronger and allows for bending the composite sandwich structure. FIG. 8B shows the series of core units, according to the present invention, that are uniformly arranged compared to structural block of PCT application WO2012/125224 shown in FIG. 8A. Also, shown in FIG. 9B, each triangular shape low-density stripe 28 is completely wrapped with the reinforcing fiber sheet including all the three corners, unlike the foam cores of PCT application WO2012/125224, shown in FIG. 9A, where at least one corner remains exposed.

The disclosed composite sandwich structures, because of their strength and bendability, can be used on boat reinforcements, wind blades, floating house platforms, and the like. The low-density stripes are used only and exclusively as an aid for positioning the reinforcing fibers in a suitable position during production. Once the product is finalized through the infusion resin process, the low-density internal stripes can provide, in addition to compactness and structure, also thermal and acoustic insulation characteristics. The disclosed composite sandwich structure has the main advantage that the low-density stripe is continuously and uniformly wrapped around all surfaces of the foam profiles, creating a highly cohesive and robust structure. This complete wrapping process with reinforcing fiber sheets for the low-density stripes is a crucial feature of the invention that leads to significant improvement in mechanical strength and reliability. The reinforcing fibers in the disclosed composite sandwich structure provide for every vertical reinforcement to be fully reinforced along all edges and in all directions. This ensures optimal distribution of the load and makes delamination virtually impossible.

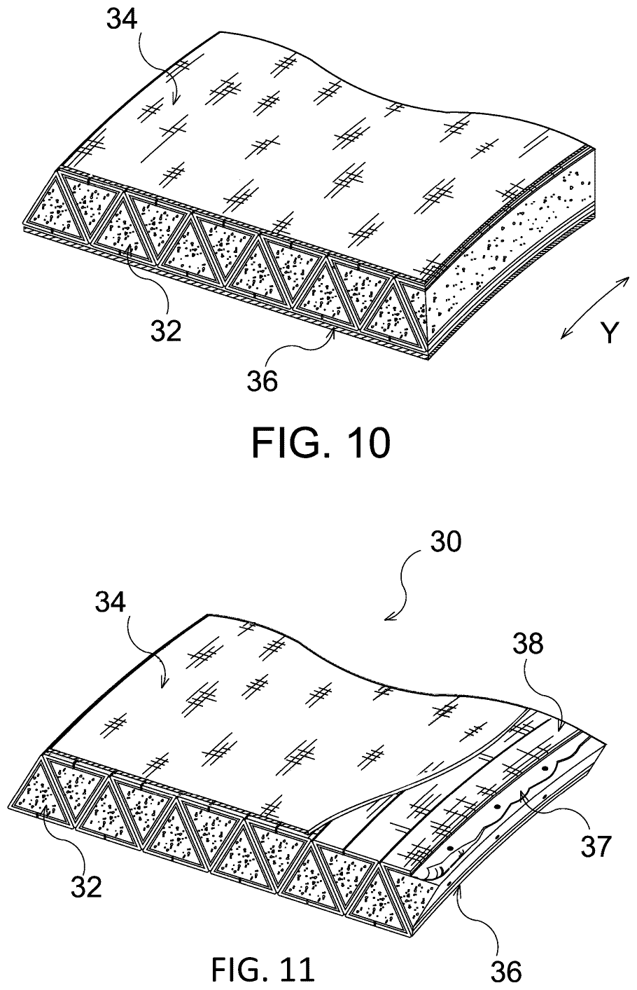

Referring to FIG. 10 which shows an implementation of the disclosed composite sandwich structure 30 which includes a series of core units 32 made of low-density strips each wrapped in a reinforcing fiber sheet; a first outer skin 34 on top facing the vacuum bag; and a second outer skin 36 that rests on the surface of the mold. The various components may be adhered to with a polymeric matrix. The polymeric matrix may be made of a resin-based material, such as a thermosetting polymer. The composite sandwich structure 30 may have a curvature in the longitudinal direction of the strips (Y direction).

The low-density strips in the composite sandwich structure 30 are arranged with their longitudinal axes substantially parallel to each other and may contain a series of holes that pass through the surfaces of the low-density strips, facing the first outer skin 34 and the second outer skin 36, respectively. A double-sided adhesive film may be used for adhering the reinforcing fiber sheet to the low-density strip to keep them securely bonded and to prevent the porosity of the low-density strips from absorbing an excessive amount of resin.

The polymeric matrix can be used to bond the top and bottom layers with the core units. The polymeric matrix may typically be made of a resin-based material such as a thermosetting polymer, thermoplastic resins, or in-situ polymerized polymers. The resins can be used in making the core units as well as for bonding the top and bottom layers with the core units. When the low-density strips have holes, the resin may penetrate these holes. In certain implementations, the low-density strips may be of a lower density than the polymeric matrix, with values ranging from 0.01 to 0.10 g/cm³.

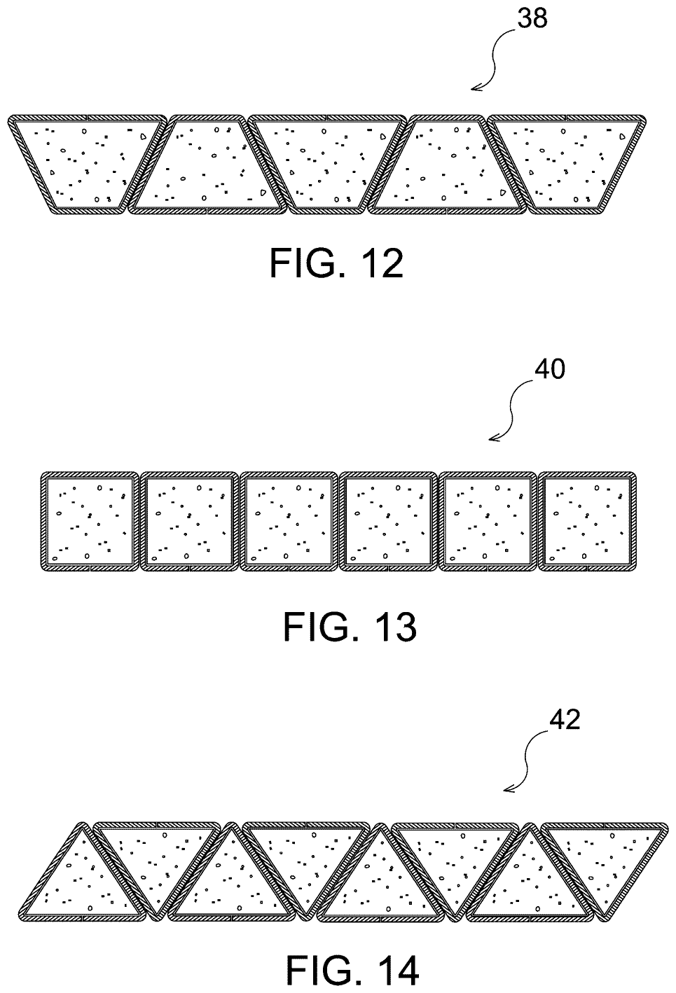

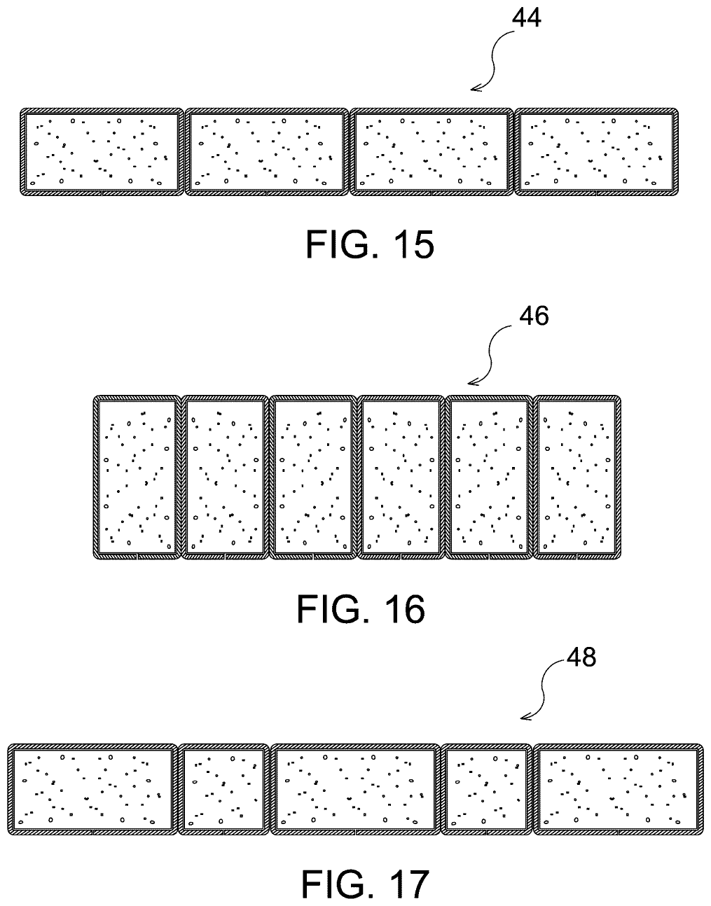

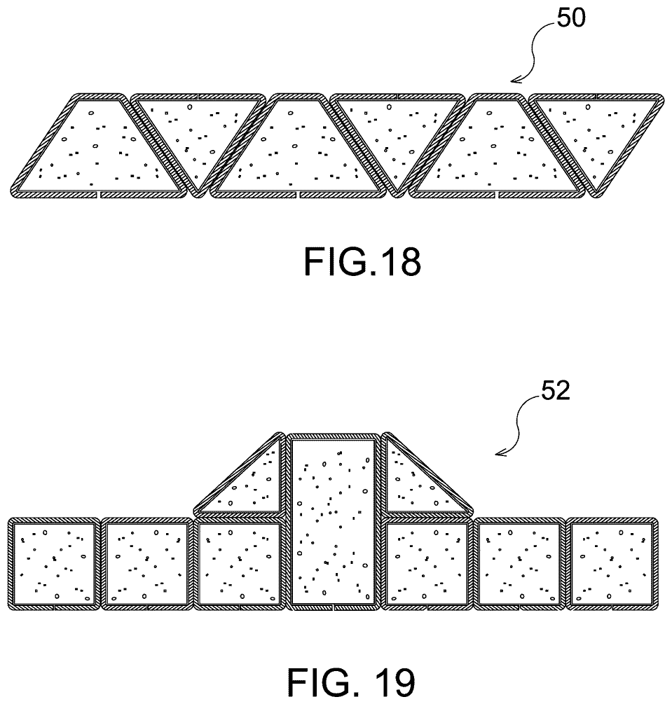

Referring to FIGS. 12-19, which show cross-sectional views of low-density strips of different shapes. FIG. 12 shows the core units 38 of trapezoid shape profile; FIG. 13 shows the core units 40 of square shape profile; FIG. 14 shows the core units 42 of triangular shape profile; FIG. 15 shows the core units 44 of rectangular shape profile arranged side-by-side at their long sides; FIG. 16 shows the core units 46 of rectangular shape profile shown arranged side by side at their short sides; FIG. 17 shows the core units 48 of mixed square and rectangular shape profiles; FIG. 18 shows the core units 50 of mixed trapezoid and triangular shape profiles; and FIG. 19 shows the core units 52 of mixed square, rectangular, and triangular shape profiles. As shown in FIG. 19, by mixing core units of different shapes, a complex shape composite structure can be made. The primary and secondary faces come in contact with the top layer and the bottom layer, respectively.

In FIGS. 12-19, the side faces of core units which contact adjacent core units when assembled, these side faces are referred to as edge faces while the exposed face is referred to as the primary face. The triangular shaped core units have one primary face that comes in contact with the top or bottom layer. The rectangular shape, trapezoid shape, and square shape core units have two edge faces, a primary face and a secondary face. Thus, edge faces of the core units couple with edge faces of adjacent core units, while the primary and/or secondary faces may bond with the top and/or bottom layers, respectively. Also, irrespective of the shape of the low-density stripe or the number of faces, each corner or edges of the low-density stripe is reinforced with the reinforcing fiber sheet. Also, all the side faces, including the primary and secondary faces and the edge faces, are reinforced with the reinforcing fiber sheet.

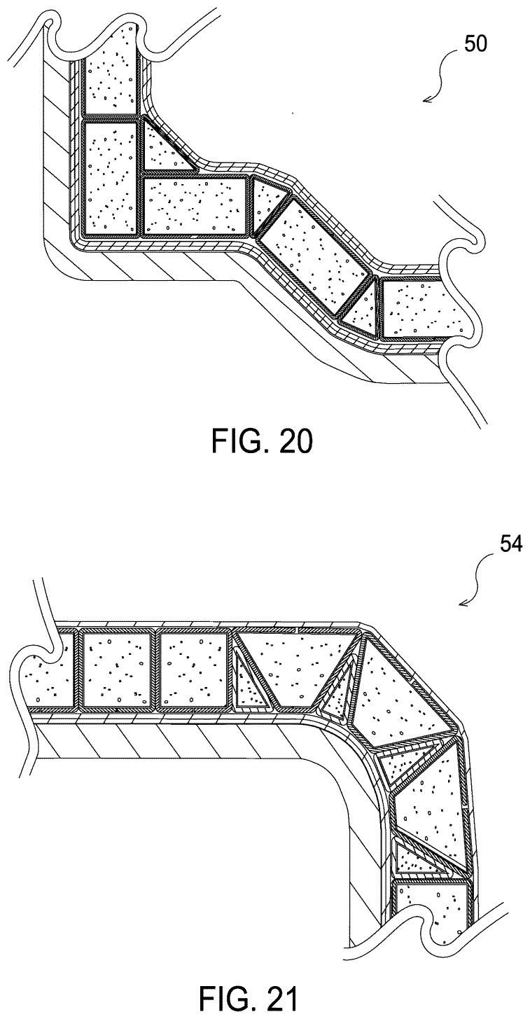

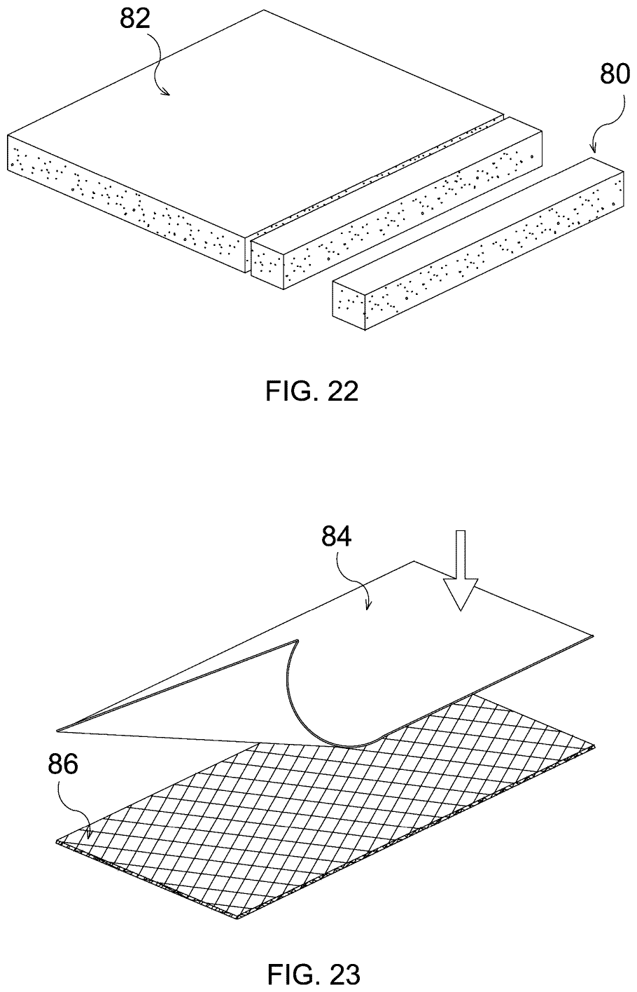

The disclosed composite sandwich structure can be used in building different-shaped structures by using a combination of low-density stripes of different shapes. The composite sandwich structure 52, shown in FIG. 19, allows for increased stiffness and strength at specific points of the final structure. In areas requiring additional strength, the low-density stripes with more frequent vertical fiber reinforcements can be used. Referring to FIG. 20, which shows a complex-shaped composite sandwich structure 53. As illustrated in FIG. 20, the disclosed composite sandwich structure can be easily adapted to more complex surfaces of the mold to be made. Similarly, FIG. 21 shows the composite sandwich structure 54 in which a 90-degree turn is made. In this case, low-density stripes with more flexible and adaptable geometries wrapped in reinforcing fiber sheets may be used. In FIG. 21, the turn is made possible by the use of trapezoid and right-angle triangle-shaped core units. The complete wrapping of reinforcing fiber sheet around the low-density stripe ensures that core units of such shape and arrangement, shown in FIGS. 21 and 22 remain durable.

In certain implementations, the low-density stripes can be made from a wide range of suitable materials, including but not limited to foams (closed or open cell), Balsa® wood, and sealed plastic profiles. The foams may include materials such as polyurethane, expanded polystyrene, expanded polyethylene, expanded polypropylene, or similar copolymers. Other options include rigid foams such as PVC, styrene acrylonitrile (SAN), polymethacrylimide (PMI), fire-resistant foams such as phenolic, or hollow tubes made of plastic, metal, or paper. A preferred embodiment uses closed-cell foams, selected based on processing requirements (pressure, temperature, chemical resistance) or desired properties in the finished panel, such as thermal insulation, water or fire resistance, or light transmission.

The low-density stripes may be designed to have a resin absorption starting from 100 g/m², influenced by the density and configuration of the closed cells of the material. To reduce resin absorption, the strips can be coated or covered with a film, preferably applied to all surfaces. Coating materials may include PVC, polyolefins, polyurethanes, and other polymers, applied by known techniques. Closed-cell foams exhibit resin absorption on the surfaces. However, with an increase in the exposed surface area of the foam (from 100% to 200%, for example), it is necessary to limit resin absorption to maintain control over the polymer matrix content (EX). An effective method is to seal the low-density strips with a PET, PVC, or paper adhesive film, creating an impermeable barrier. This reduces resin absorption, optimizes the polymer matrix content, and improves the final composite structure.

Some films or coatings may affect the adhesion between the surface of the foam of the low-density stripe and the reinforcing fiber sheet. However, since the reinforcing fiber sheet fully wraps the low-density stripe, any reductions in surface bonding do not compromise the mechanical properties of the structure. Also, a waterproof coating can be chosen to promote adhesion between the low-density stripe and the reinforcing fiber sheet, further improving the overall mechanical characteristics of the composite sandwich structure.

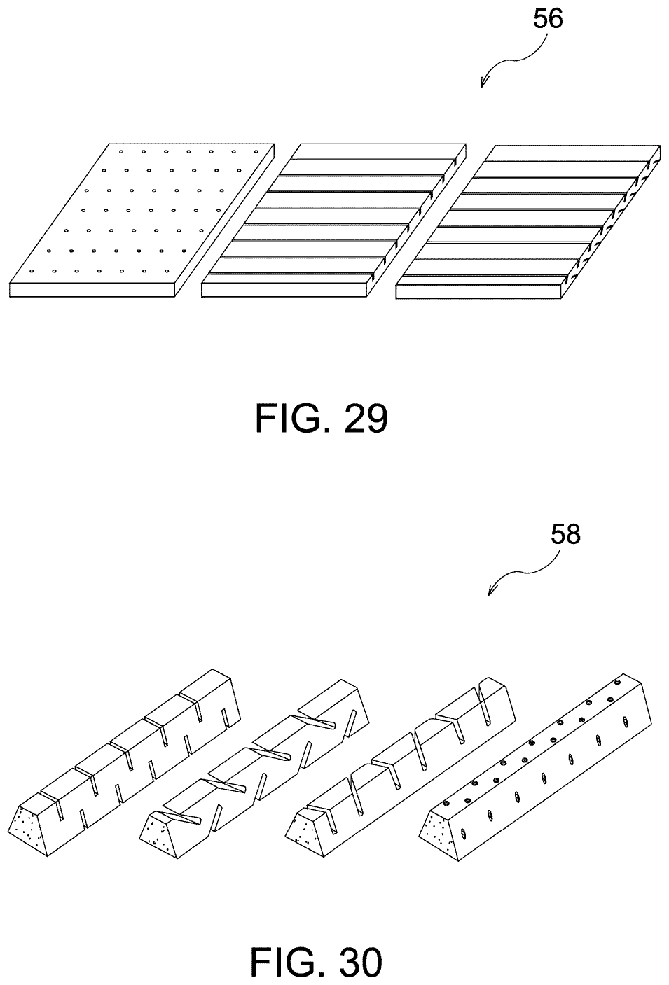

The core units, when arranged in series, may be referred to as the core panel. The low-density stripes used in the core panel may have cuts. In such a case, a double-sided adhesive sheet may be discouraged as it may close the cuts, thus preventing the resin from draining during the polymer matrix EX infusion process. This cutting solution allows for better resin flow but dramatically increases the final weight of the product. It is important to note that the porosity of the low-density stripe is evenly distributed throughout its structure, leading to resin absorption not only on the external surfaces but also on the cuts made. Rigid low-density foam panels 56, treated with holes or cuts outs are typically represented as shown in FIG. 29. From these foam panels 56, the stripes 58 of desired shapes, thicknesses, and lengths can be obtained through a cross-sectional cut along the direction of the cut outs, which may include a series of cut outs or holes, as shown in FIG. 30.

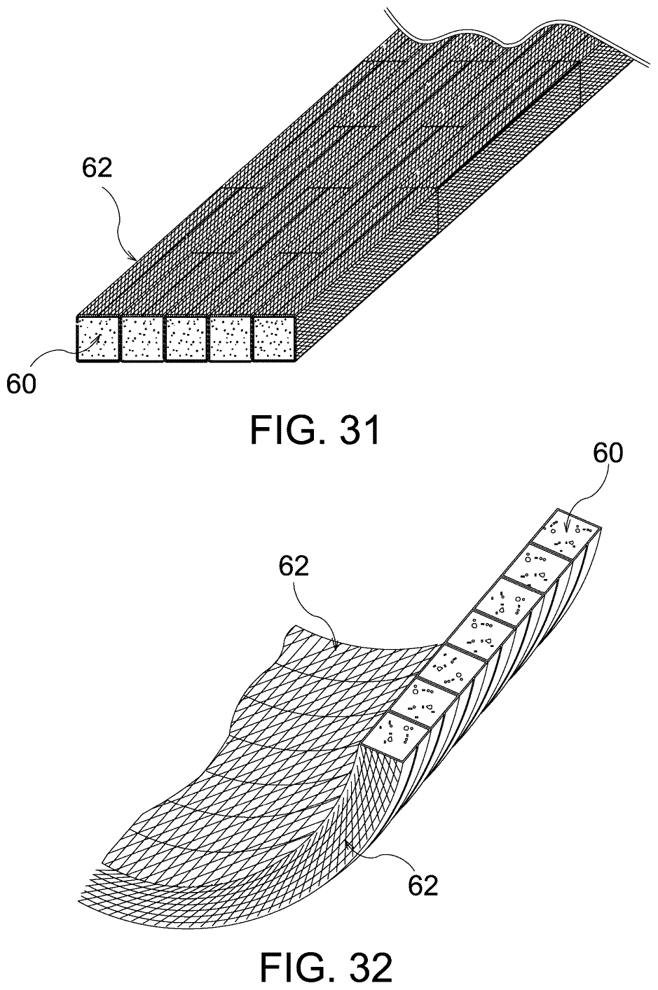

One of the main advantages of this invention is the uniform distribution of fiber reinforcements throughout the entire structure, regardless of its size, which can range from small to large dimensions. As shown in FIG. 31, it can be seen how the arrangement of the low-density stripes 60, each wrapped in a reinforcing fiber sheet 62 in a “brick” configuration, allows the fiber reinforcements 62 to remain vertically aligned throughout the structure. This provides a uniform distribution of mechanical stresses, avoiding interruptions in the reinforcement flow, thus ensuring optimal performance, especially for large-sized structures.

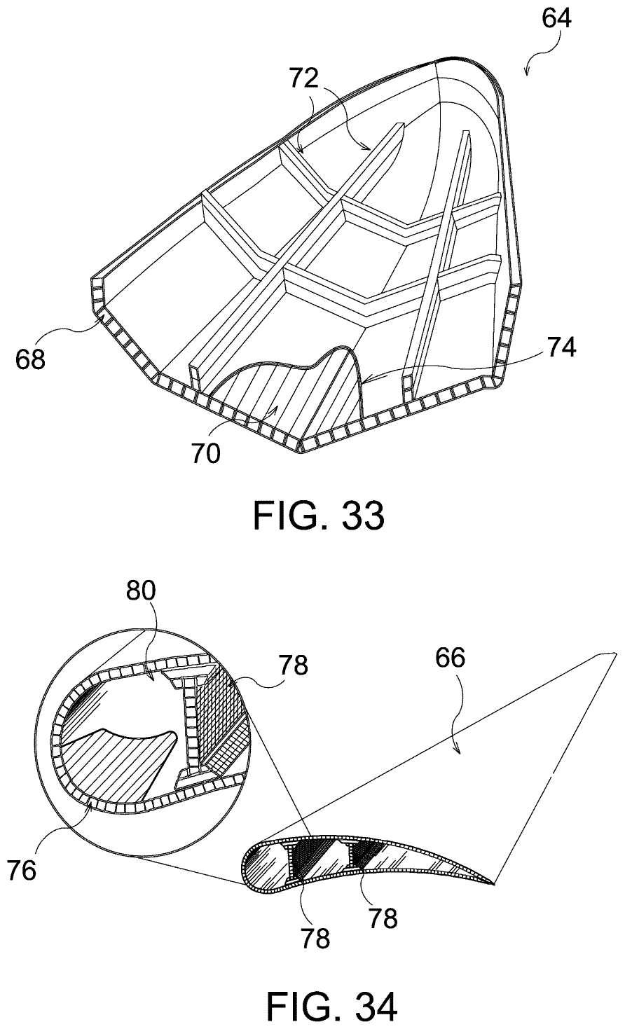

Referring to FIG. 32, the disclosed composite sandwich structure allows the bending of the low-density strips 60, each wrapped with reinforcing fiber sheet 62, uniformly without causing breakage. The ability to divert the strip without compromising its integrity is made possible because of the unique wrapping process of the reinforcing fiber sheet around the low-density stripe. This advantage allows for the construction of complex structures, such as longitudinal or transverse beams on bodies in boat hulls 64 (shown in FIG. 33) or wind turbine blades 66 (shown in FIG. 34), which normally require externally made panels that are subsequently bonded. FIG. 33 shows how, using a series of low-density strips 68 each wrapped with reinforcing fiber sheet, the entire surface of a body 70 can be created. The body is shown by removing a section of the first outer skin 74. Longitudinal and transverse beams 72 are formed by placing one strip over another, thus creating the internal structure of the designed boat 64. This is an exemplary case of the versatility of the invention, which can be applied to many other types of structures.

FIG. 34 illustrates creating an entire surface of a body 76 using low-density strips wrapped with a reinforcing fiber sheet. Again, longitudinal beams 78 are created by arranging the strips one over another, forming the internal structure of the designed wind turbine blade 66. Also, shown is the upper sheet 80. The wind turbine blade 66 illustrates the great versatility of the invention, which can be adapted to a wide range of applications.

The reinforcing fiber sheet can be made from various types of fabrics, including woven, knitted, bonded, non-woven (such as a mat of chopped fibers), or in the form of fiber sheets. It may be made from unidirectional fibers, such as roving, which are held together by binding, knitting a binding thread through the roving, or weaving a binding thread that crosses through the roving itself. In the case of fabrics, knitting, warp/weft mesh, non-woven or bonded materials, the material can be composed of yarns or ribbon elements arranged in a multi-(bi- or tri-) axial direction. The yarns or fibers in the reinforcing fiber sheet can be made from different materials such as glass fiber, carbon, polyester, aramid, nylon, natural fibers, and their blends. The continuous reinforcing fiber sheet is preferably made from a multi-axial mesh. This mesh features high-modulus fibers, non-crimped, oriented to meet specific shear and compression requirements. The fibers used can be monofilament, multifilament, tow, ribbon elements, or a mix of these. Glass roving is particularly valued for its low cost, relatively high modulus, and good compatibility with a wide range of resins.

The fiber reinforcing sheet RF can also be pretreated with thermosetting or thermoplastic resin before combining with the foam strips. The resin may be impregnated directly into the fibers (prepreg), layered in the form of a film next to the fiber sheets (as in the case of SPRINT® by Gurit), or mixed with the reinforcing fibers (as in the case of TWINTEX® by Saint Gobain®). The pre-combination of resin and reinforcement offers numerous advantages, including the ability to use dry processes with similar films. These processes allow for better control over the resin-to-fiber ratios, potentially reducing the weight of the final product. Moreover, greater precision in the manufacturing processes results in fewer chances of voids or defects. However, the main disadvantage of prepreg processes lies in the higher material acquisition costs, requiring controlled storage and higher capital expenditure for processing, such as heating or the use of autoclaves.

Again, referring to FIG. 11, in one of the possible configurations, the composite sandwich structure is made up of a series of rigid foam blocks 32 in series wrapped by a double-sided adhesive tape 37 and a layer of reinforcing fiber 38, the upper external skin 34, and a lower external skin 36. In another variant, the disclosed composite sandwich structure may feature only one of the two skins, either upper or lower. The upper outer skin may be made with materials and/or construction techniques that are the same or different from the lower outer skin. The outer skins can be made from one or more layers of fibers. Preferably, the composition of the outer skin involves at least two layers of fibers. The fibers that can be used for the construction of the outer skins include, but are not limited to, organic or inorganic reinforcement fabrics, such as glass fiber, carbon fibers, aramid fibers, polyethylene or polypropylene fibers, thermoplastic fibers, polyester fibers, nylon fibers, or natural fibers. The materials and structures used in the upper and lower skins may also differ within the layers of the skins themselves.

In another implementation, the disclosed composite sandwich structure can be made from two or more adjacent reinforced core panels. In these core panels, the low-density strips forming the core panels can be arranged either parallel or rotated 90 degrees relative to each other. Additionally, a supplementary reinforcement layer, similar to that of the outer and lower skins, can be added between the reinforced core panels. Subsequently, the outer skins, i.e., upper and lower skins, may be added to the top and bottom of the reinforced central panels, respectively.

The disclosed composite sandwich structure may be impregnated or infused with a polymeric matrix of resin that flows, preferably under differential pressure. During the infusion process, the resin flows through all the reinforcing fibers of the reinforcing fiber sheet, outer skins, and any stabilizing layers, and polymerizes to form a rigid, load-bearing structure. Usable resins include, but are not limited to, polyester, vinyl ester, epoxy resin, bismaleimide resin, phenolic resin, melamine resin, silicone resin, and thermoplastic monomers. Epoxy resin may be preferred for its compatibility with low-density strips, preventing these strips from dissolving in cases where polystyrene strips may be used, while vinyl ester may be advantageous due to its lower cost, excellent mechanical properties, good processing time, and rapid polymerization. The reinforcing fabric may also be combined with the resin before wrapping the low-density strips. The resins can be thermosetting at B stages, as in prepregs, or thermoplastic resins, such as in ribbon yarns, mixed yarns, or unidirectional sheets.

The resin infusion into the porous reinforcing fibers under differential pressure can be carried out through processes, such as vacuum bag molding, resin transfer molding, or vacuum-assisted resin transfer molding (VARTM). In the VARTM molding process, the core and skins are sealed in a hermetic mold, usually with a flexible face. The air is evacuated from the mold, creating atmospheric pressure on the flexible face, which shapes the composite sandwich structure to the mold. The catalyzed resin is drawn into the mold, usually through a resin distribution network or channels designed on the surface of the panel, and then hardened. The disclosed composite sandwich structure can be optimized for resin flow with the aid of grooves or channels cut out into the primary and secondary faces of the low-density strips; a network of grooves on the sides of the low-density strips; or additives in the reinforcing fabric, such as filaments or voids to facilitate the flow. Additional fibers or layers, such as those for surface flow, can be integrated into the composite structure to enhance the resin infusion.

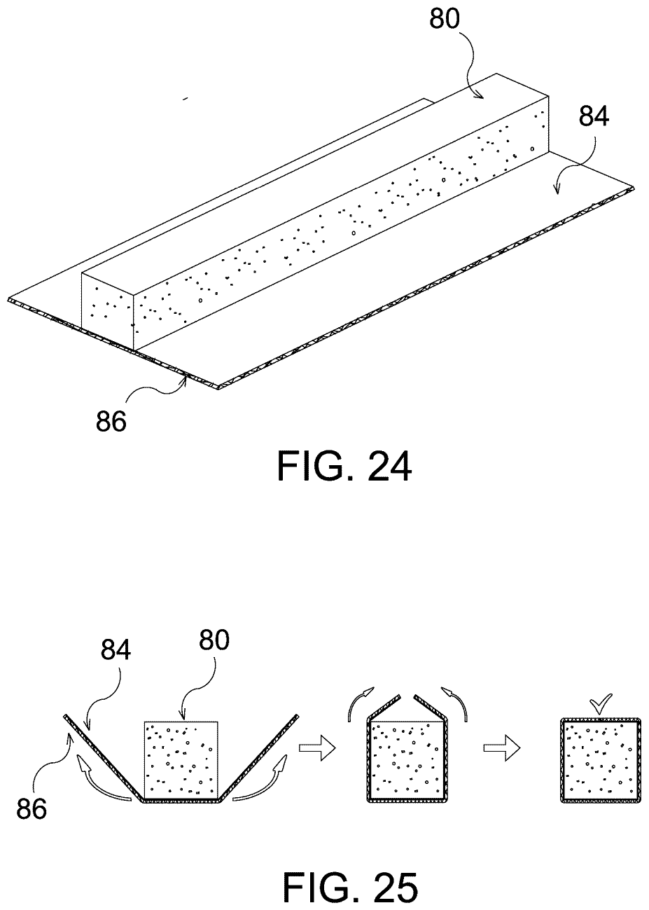

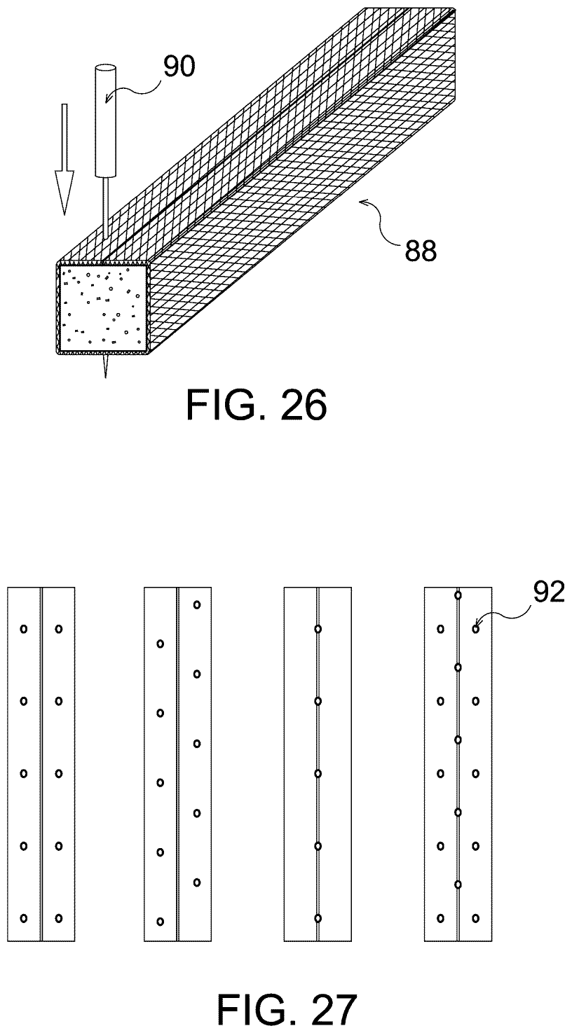

Referring to FIG. 22 which illustrates cutting of low-density strip 80 from a foam panel 82. The low-density strips of desired shapes in the form of blocks can be cut using suitable tools or machines from the foam panel. Separately, a double side adhesive sheet 84 can be applied to reinforcing fiber sheet 86, shown in FIG. 23. Thereafter, the low-density strip 80 can be placed over the double side adhesive sheet 84, shown in FIG. 24. Shown in FIG. 25, the opposite edges of the reinforcing fiber sheet 86 can then be lifted in the direction of arrows and wrapped around the low-density strip 80. The opposite edges of reinforcing fiber sheet 86 contact each other, thus almost completely wrapping around the low-density strip 80. The core unit 88 formed in FIG. 25 can be further perforated, as shown in FIG. 26. A perforating tool 90 may be used to make the perforations in the core unit. FIG. 27 illustrates different types of perforations 92 that can be made in the core unit 88.

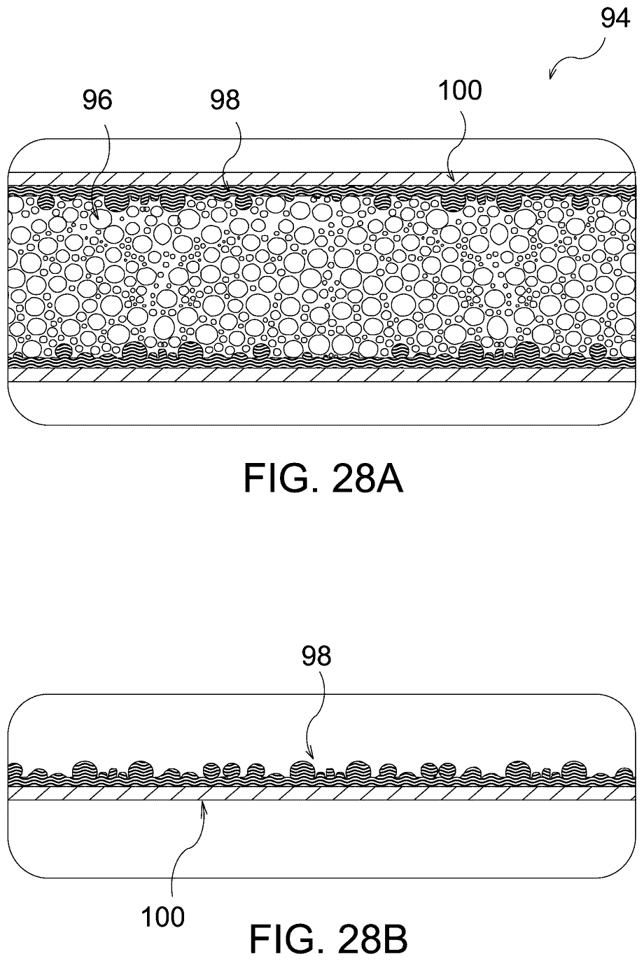

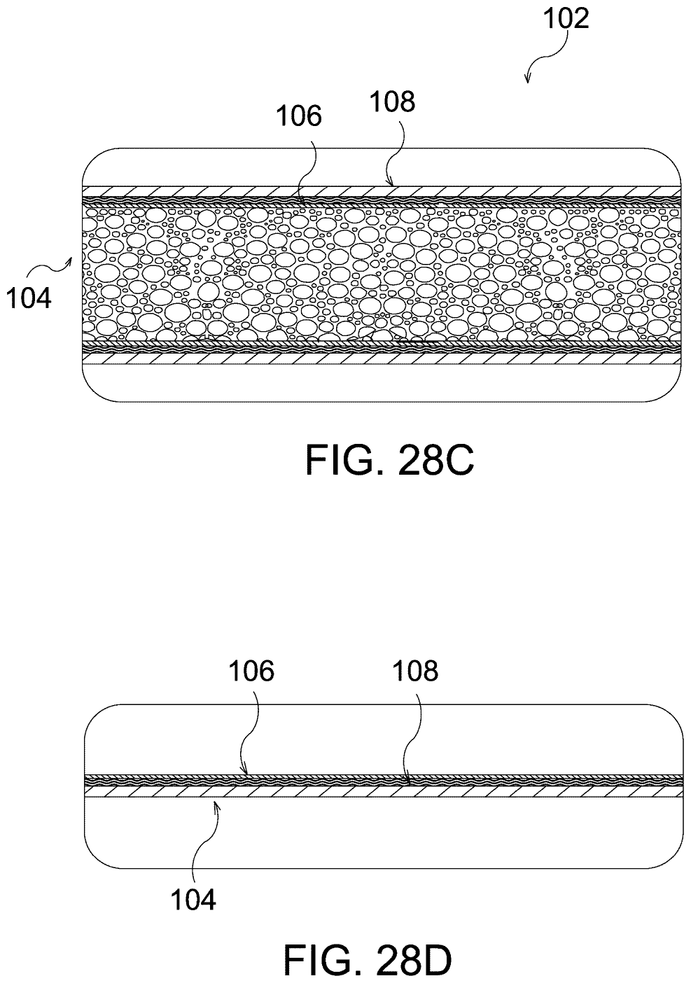

FIG. 28A shows a detailed view of a composite sandwich structure 94 in which a low-density stripe 96 has an excess polymer matrix 98, caused by the porosity of the stripe 96 itself and the presence of a reinforcing fiber sheet 100. FIG. 28B illustrates a detailed view of the excess polymer matrix (EX), caused by the porosity of the surface of the low-density stripe and the reinforcing fiber. FIG. 28C represents a detailed view of a composite sandwich structure 102 in which a low-density stripe 104 has no excess polymer matrix, due to the use of a double-sided adhesive film 106 and a reinforcing fiber sheet 108. FIG. 28D illustrates a detailed view of the result achieved with the double-sided adhesive film 106, which ensures impermeability and reduces the excess polymer matrix, keeping the reinforcing fiber sheet 108 in optimal position.

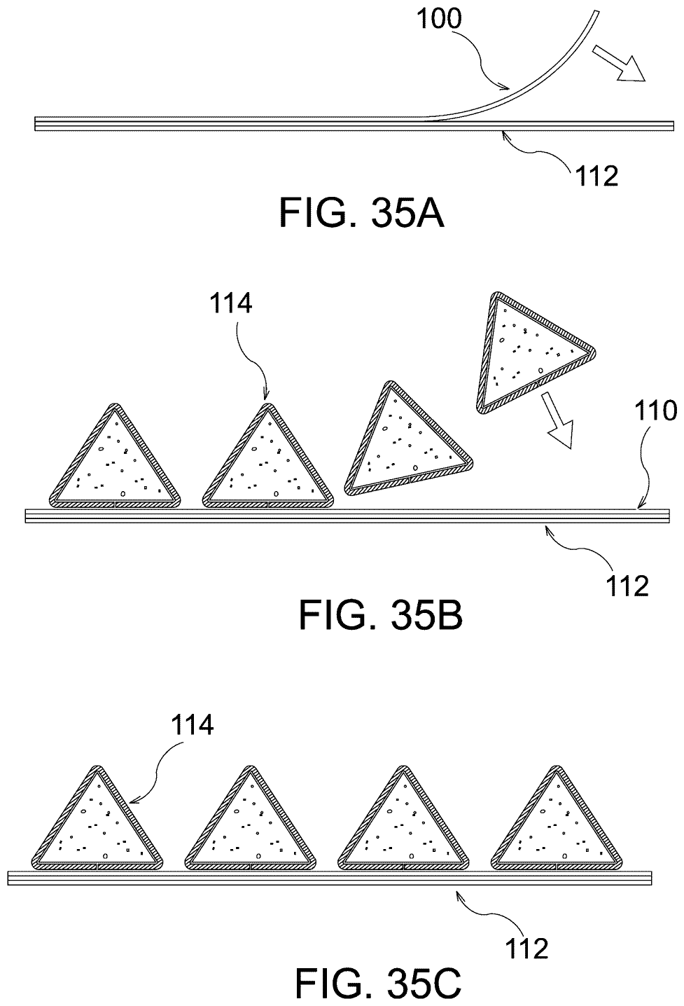

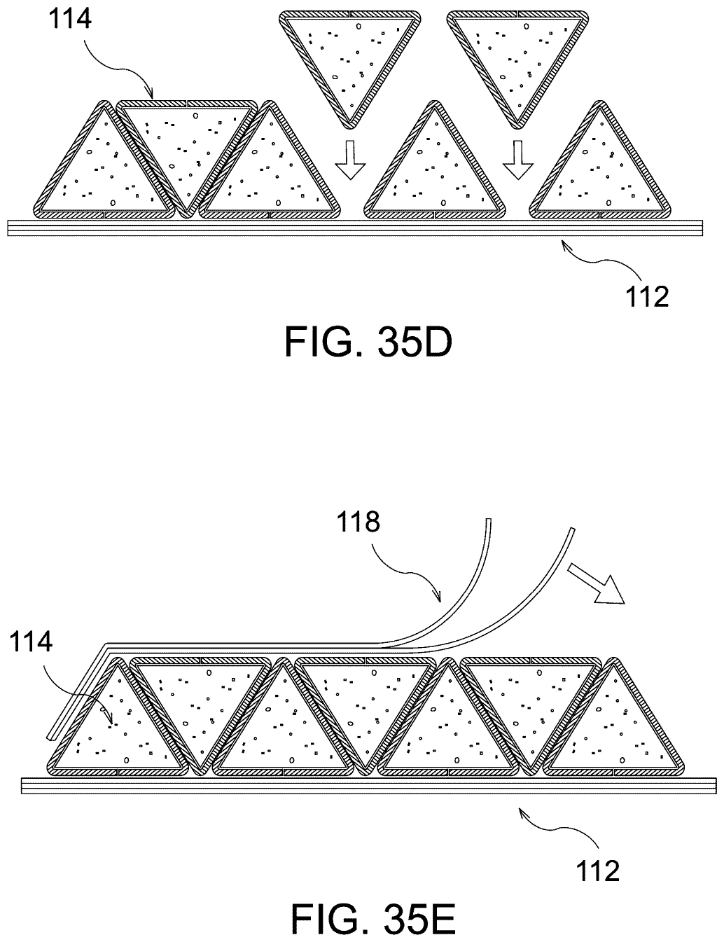

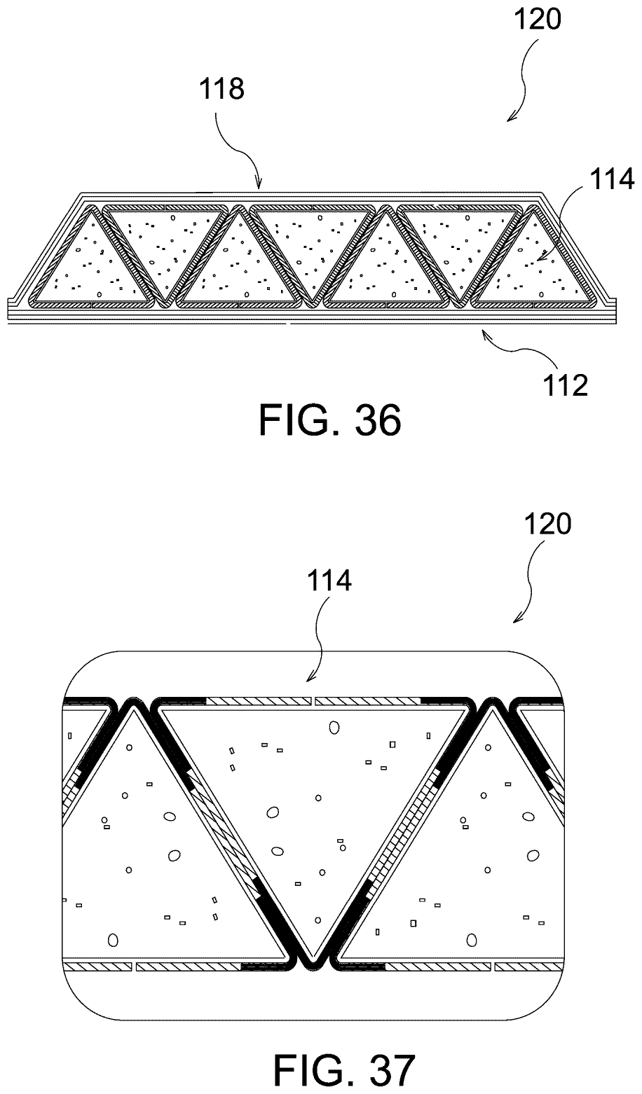

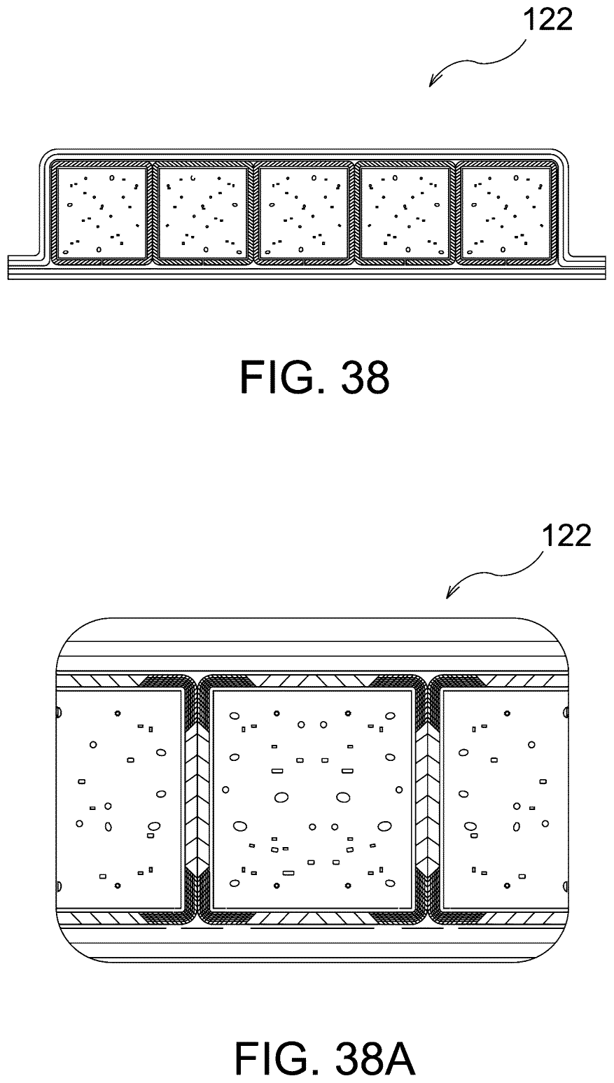

FIGS. 35A-35E illustrates the necessary phases for making the composite sandwich structure according to the method described in this document. FIGS. 35A-35E illustrates the use of low-density stripes of triangular shape pre-wrapped with reinforcement fiber sheet as explained above. First, layers of reinforcing fiver sheet 110 are laminated to create the outer lower skin 112, as shown in FIG. 35A. Next, core units 114 may be placed in series on the outer lower skin 112 either by simply laying then down or by using a spray glue to facilitate attachment. FIG. 35C shows the first set of core units 114 placed over the lower outer skin 112. Next, FIG. 35D shows the positioning of the second set of core units, i.e., one at a time between the two core units. Once done, it is possible to apply the outer top skins 116 and 118 (the skins 116 and 118 may be of same material i.e., reinforcing fibers that are positioned possibly with the use of spray adhesives), as shown in FIG. 35E. FIG. 36 shows the composite sandwich structure 120 made by using the above process. FIG. 37 shows an enlarged view of the composite sandwich structure 120 to illustrate that all corners and edges of the low-density stripes in the core units are completely wrapped, and therefore reinforced, by the reinforcing fiber sheets. FIG. 38 shows the composite sandwich structure 122 made using the square-shaped core units.

### Lamination and Preparation for Infusion

Once the lamination of the composite sandwich structure is completed, then the preparation for infusion by laying out the necessary auxiliary materials, including peel-ply, micro-perforated film, flow mesh, resin tubes, vacuum tubes, and the vacuum bag, can be carried out. The panel can be placed in a vacuum bag and impregnated via infusion with an epoxy resin mixture. At the end of the infusion process, and after 24 hours, the mold underwent post-curing following the procedure recommended by the epoxy resin manufacturer. Finally, the panels were cut with a flexible cutter to obtain the desired surface size.

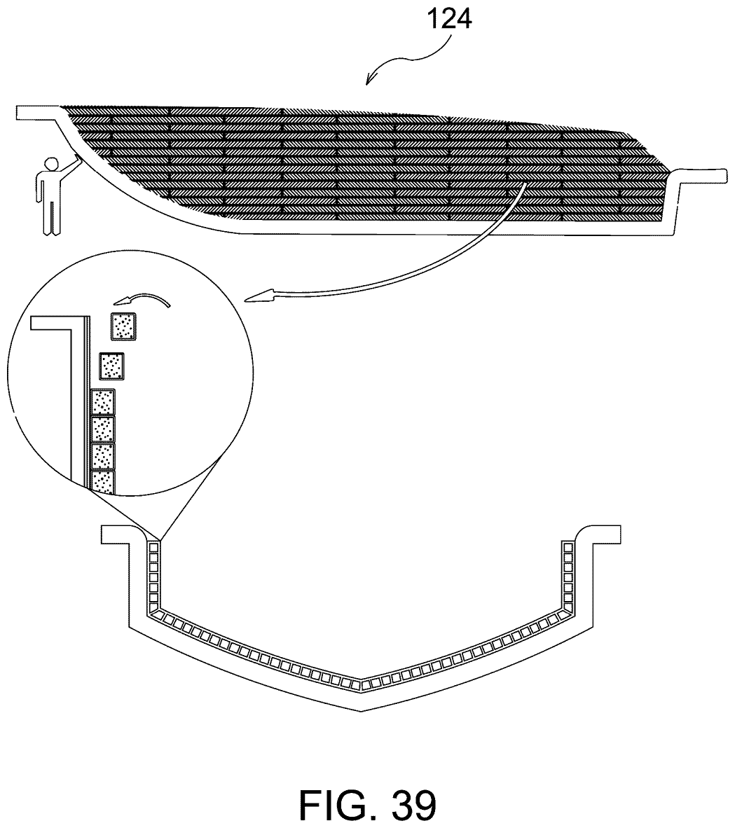

FIG. 39 shows the making of a hull 124 using the disclosed sandwich composite structure. The core units can be arranged easily to any mold shape by placing the desired shape and size of core unit, one-by-one, as shown in the drawing.

### EXPERIMENTATION

To highlight the uniqueness of the disclosed composite sandwich structure, a comparison was conducted between the disclosed composite sandwich structure and a structure made by the process taught by Tompkins et al. (WO 2012/0125224 A1). To ensure the highest level of accuracy, both panels were produced using the same materials and quantities, including low-density strips, fibrous reinforcing sheets, polymeric matrix or double-sided adhesive sheet, the same vacuum infusion bag process, and the same resin mixed with a specific hardener. A single MLD mold (composite panel) was used for the lamination of two practically identical sandwich panels, using the same amount of materials (reinforcing fibers and core foam profiles). Panels of size 450×143 mm were used for the tests.

Two tests were conducted to compare the two configurations of the disclosed composite sandwich structure and the prior art panel. In the first test, triangular-shaped low-density strips were used, and the low-density strips of square shape were used in the second test.

The disclosed panel 120 was made using the low-density strips of triangular shape, which are completely wrapped by reinforcing fiber sheets as described above. In the disclosed panel 120, each cross-sectional face is reinforced twice due to the adjacency of two strips. In contrast, in the prior art panel, the reinforcement fiber is placed above and below each low-density strip, creating a single-layer reinforcement between the two strips.

To ensure parity between the two panels in the breakage test, it was ensured that both panels had the same amount of reinforcement fibers. Therefore, the low-density strips in the disclosed panel 120 were wrapped with a single layer of 600 g Biax+/−45 reinforcement fiber, while those in the prior art panel were wrapped with a double layer of 600 g Biax+/−45 reinforcement fiber. The lamination of the panels was identical, with three 600 g layers (two Biax 0/90 and one Biax+/−45) on the surface facing the mold (BS) and two layers on the outer part (US) (one 600 g Biax 0/90 and one 600 g Biax+/−45), facing the vacuum bag. To ensure the highest reliability of the test, both panels were produced using the same MLD mold, the same vacuum bag, and the same epoxy resin matrix EX for the infusion process.

### Breakage Test

To determine the breakage load of each sandwich composite structure, a certified universal materials testing machine according to the “ASTM D7249 Bend Fixture” standard (UTM-Universal Testing Machine) was used. This tool was employed to perform a series of mechanical tests, including Compression Tests: Used to determine the maximum load the panel can withstand before breaking under compression; Flexural Tests: Used to measure the resistance to bending and the breakage point of the panel, and Shear Tests: To evaluate the resistance to sheer of the core or adhesives used between the panel layers.

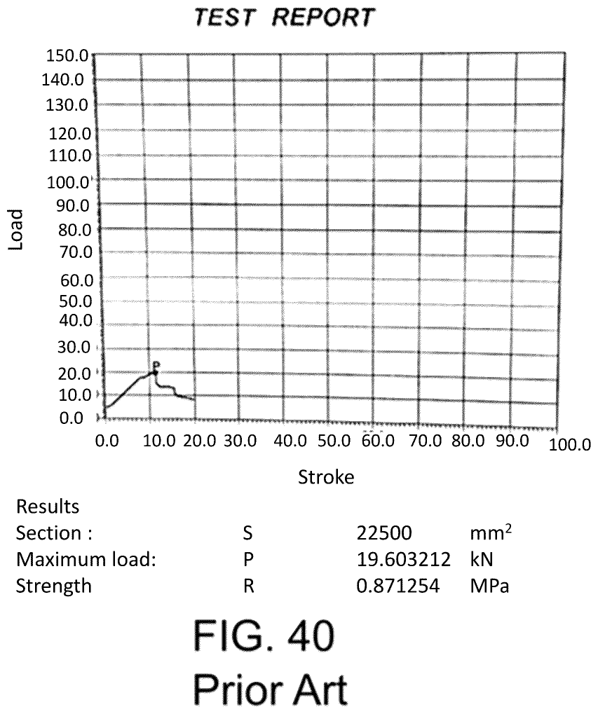

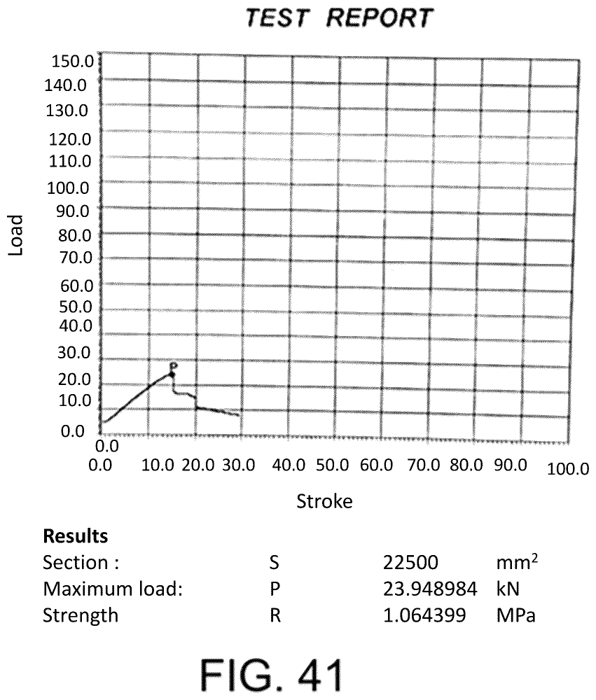

FIG. 40 shows the test results for the prior art panel made using triangular-shaped low-density stripes, and FIG. 41 shows the test results for the disclosed panel 120.

TABLE 1
Test results for composite panels made
with triangular-shaped core units.

| | Prior art panel | | | |
|---|---|---|---|---|
| OBJECT | (WO2012/125224) | | Panel 120 | |
| DIMENSIONS | 420 × 143 mm | | 420 × 143 mm | |
| | (16.5 × 6.5 inches) | | (16.5 × 6.5 inches) | |
| WEIGHT | 622 gr | | 561 gr | |
| | (21.9 oz) | | (17.9 oz) | |
| MATERIAL | Carbon fiber/epoxy | | Carbon fiber/epoxy | |
| | resin/Polystyrene | | resin/Polystyrene | |
| | core | | core | |
| MAX LOAD | 19.6 | kN | 23.95 | kN |
| FORCE | 0.8712 | MPa | 1.0644 | MPa |

| | | |
|---|---|---|
| DELAMINATION | Apparent Delamination | Apparent Delamination |

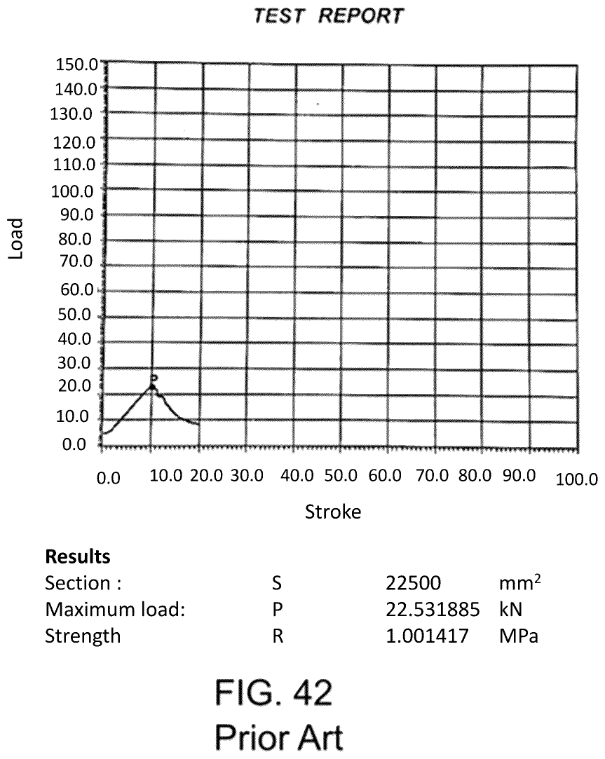

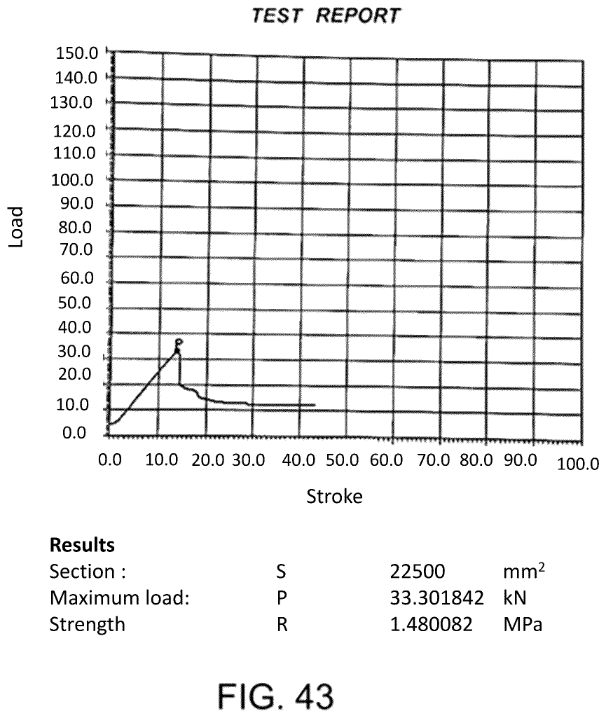

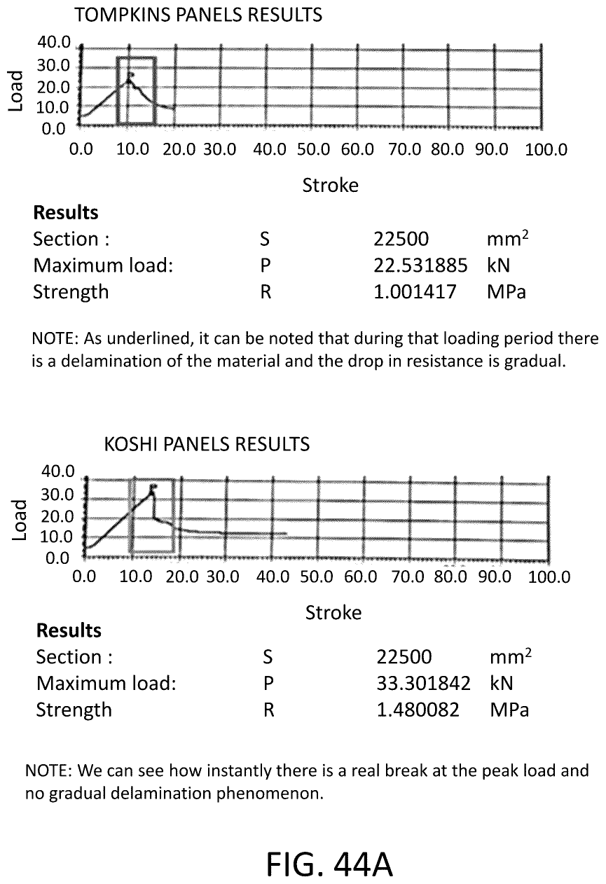

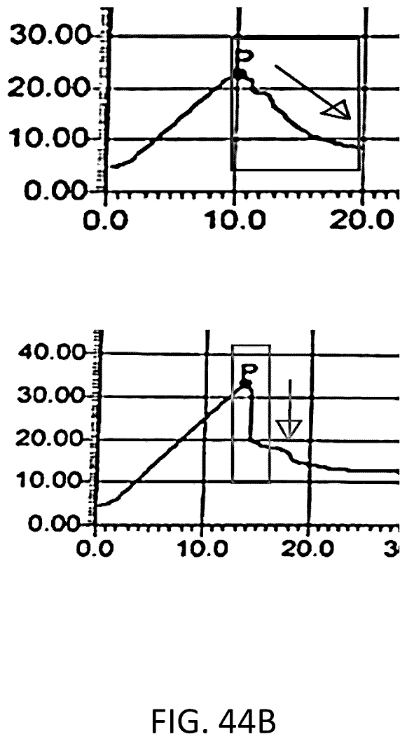

FIG. 42 shows the test results for a prior art panel made using square-shaped low-density stripes, and FIG. 43 shows the test results for the disclosed panel 122 (shown in FIG. 38). FIGS. 44A and 44B show the comparison of results for the two tests.

TABLE 2
Test results for composite panels
made with square-shaped core units.

| | Prior art panel | | | |
|---|---|---|---|---|
| OBJECT | (WO2012/125224) | | Panel 122 | |
| DIMENSIONS | 450 × 143 | mm | 450 × 143 | mm |
| WEIGHT | 1132 gr | | 1062 gr | |
| | (39.9 oz) | | (37.46 oz) | |
| MATERIAL | Carbon fiber/epoxy | | Carbon fiber/epoxy | |
| | resin/Polystyrene | | resin/Polystyrene | |
| | core | | core | |
| MAX LOAD | 22.53 | kN | 33.30 | kN |
| FORCE | 1.001417 | MPa | 1.480082 | MPa |

| | | |
|---|---|---|
| DELAMINATION | Apparent Delamination | No delamination/ only |
| | | breaking |

Since the two tests' panels were made using the same materials, impregnated under vacuum infusion in the same vacuum bag with the same resin, ensuring that both panels underwent the same production process, albeit with different lamination systems. Based on this, it may be concluded that the disclosed panels exhibit a breakage load resistance 47.8% higher than that of the prior art panel. Moreover, it was observed that the prior art panel easily delaminated, but the disclosed panel showed no delamination even at higher stresses. This is a crucial aspect, as it means the disclosed panel remains intact up to the breaking point. In contrast, other panels tend to delaminate at much lower forces than their breaking point. In practical terms, this implies that when using a composite structure made using conventional methods, there could be a scenario where the structure has failed internally due to delamination, despite appearing visually intact. This poses a significant risk, especially for structures subjected to continuous stress. The disclosed process overcomes the said drawback with conventional technologies, as there is no delamination, and the loss of suitability for use is easily identifiable due to the visible structural breakage, thus reducing the risk of undetected damage.

Thus, the present invention discloses a construction solution that significantly improves the mechanical strength of panels compared to known technologies. The innovative aspect lies in the complete wrapping of each rigid foam block with reinforcing fibers, resulting in a unified, more robust structure. In contrast, conventional methods typically involve only partial reinforcement, leaving structurally weaker areas. The superiority of the proposed configuration is demonstrated through comparative testing, as presented in this application, which shows a significant increase in failure loads compared to panels manufactured using conventional techniques.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A composite sandwich structure comprising:
a plurality of core units, wherein each core unit comprises:
a low-density stripe fully wrapped around with a reinforcing fiber sheet, the reinforcing fiber sheet is adhered to the low-density stripe using an adhesive;
an outer upper skin; and
an outer lower skin, wherein the plurality of core units are arranged side-by-side in series and sandwiched between the outer upper skin and the outer lower skin.

2. The composite sandwich structure of claim 1, wherein one or more core units of the plurality of core units are of different shapes.

3. The composite sandwich structure of claim 2, wherein the plurality of core units comprises the core units of trapezoidal shape and the core units of triangular shape.

4. The composite sandwich structure of claim 2, wherein the plurality of core units comprises the core units of square, rectangular, and triangular shapes.

5. The composite sandwich structure of claim 2, wherein the adhesive is a double adhesive tape.

6. The composite sandwich structure of claim 2, wherein the adhesive is a spray glue.

7. A core unit for a composite sandwich structure comprising a low-density stripe fully wrapped around with a reinforcing fiber sheet, the reinforcing fiber sheet is adhered to the low-density stripe using an adhesive.

8. The core unit of claim 7, wherein the low-density stripe is triangular.

9. The core unit of claim 7, wherein the low-density stripe is trapezoidal.

10. The core unit of claim 7, wherein the adhesive is a double adhesive tape.

11. The core unit of claim 7, wherein the adhesive is a spray glue.

12. A method of manufacturing a composite sandwich structure, the method comprising:
cutting low-density stripes from a foam core panel;
wrapping each low-density stripe with a reinforcing fiber sheet, such that the low-density stripe is fully wrapped around, to obtain core units, the reinforcing fiber sheet is adhered to the low-density stripe using an adhesive;
positioning the core units over a lower outer skin side-by-side in series; and
layering an outer upper skin over the series of the core units forming the composite sandwich structure.

13. The method of claim 12, wherein one or more of the core units are of different shapes.

14. The method of claim 12, wherein a core unit of a first shape and a core unit of a second shape are positioned together.

15. The method of claim 14, wherein the first shape is trapezoidal, and the second shape is triangular.

16. The method of claim 12, wherein the adhesive is a double adhesive tape.

17. The method of claim 22, wherein the adhesive is a spray glue.
